(19) United States
(12) Patent Application Publication
(10) Pub. No.: US 2020/0222921 A1
(43) Pub. Date: Jul. 16, 2020

(54) Device For Dispensing A Fluid Medium

(71) Applicant: Robatech AG, Muri (CH)

(72) Inventor: Beatus Ineichen, Weggis (CH)

(73) Assignee: Robatech AG, Muri (CH)

(21) Appl. No.: 16/743,140

(22) Filed: Jan. 15, 2020

(30) Foreign Application Priority Data
Jan. 16, 2019 (EP) 19152086.5

(51) Int. Cl. B05B 1/30; F16K 41/10

(52) U.S. Cl. CPC B05B 1/3013; F16K 41/10

(57) ABSTRACT

A device for dispensing a fluid medium comprises a head portion and a base body portion, and further comprises a cavity for receiving the fluid medium, wherein the head portion comprises a dispensing opening leading into the cavity for dispensing the fluid medium, wherein the device further comprises a rod that is displaceable in an axial direction between a first end position and a second end position and comprises a sealing portion at a first end portion of the rod that in the first end position is arranged spaced from the dispensing opening and in the second end position closes the dispensing opening on a side facing the cavity. A second end portion of the rod is guided out of the cavity for coupling the rod to an actuator, wherein the device further comprises a seal for sealing the second end portion with respect to the cavity. The seal comprises a first seal portion connected stationary to the rod and a second seal portion that abuts in a stationary manner against a wall delimiting the cavity, wherein the seal comprises an area of elasticity between the first seal portion and the second seal portion and in the second end position of the rod is stretched in the axial direction in relation to an initial state of the seal.

### FIELD OF THE INVENTION

The present invention relates to a device for dispensing a fluid medium, wherein the fluid medium is preferably an adhesive, in particular a hot glue or hot melt adhesive.

### BACKGROUND OF THE INVENTION AND RELATED ART

Such devices are used, for example, for applying a fluid medium to a substrate in portions. In this case, the application of the fluid medium takes place in a controlled manner, wherein the device comprises a dispensing opening for dispensing the fluid medium, wherein this dispensing opening can be closed and opened by means of a sealing portion of a rod which can be moved by an actuator. In this regard, the device comprises a closable valve.

Devices for dispensing a fluid medium are known, for example, from DE 10 2015 000 630 B3, EP 2 308 602 B1, U.S. Pat. No. 7,617,955 B2 and U.S. Pat. No. 8,333,307 B2.

In terms of the devices for dispensing a fluid medium of the above-mentioned type, a particular problem consists in preventing the fluid medium from reaching the region of the actuator. To seal the actuator with respect to the fluid medium, in particular a cavity receiving the fluid medium, seals are used, wherein two different types of seal are essentially known for this purpose.

One is a so-called “dynamic seal”, wherein, in the case of a “dynamic seal”, the seal or the sealing element is formed or arranged between two mutually relatively moving surfaces during operation of the device. A disadvantage of this type of sealing is that, over long-term operation of the device, the dynamic seal becomes worn and, as a consequence of this, the seal loses its sealing effect, which can result in an undesired penetration of fluid medium into the region of the actuator.

So-called “bellows seals” are furthermore known from the prior art. In contrast to a dynamic seal, in the case of a bellows seal, sealing does not take place between two mutually moving surfaces; rather, the bellows seal is statically connected to the rod element by a first portion and statically connected to a further element of the device by a second portion, wherein the rod moves relative to the second element of the device. The movement of the rod in relation to the element of the device is accommodated by a deformation of the bellows seal. This also ensures very good leak-tightness over long-term operation of the device, since only low frictional forces occur at the seal.

Devices for dispensing a fluid medium which comprise a bellows seal for the purpose of sealing an actuator, are known for example from DE 10 2015 000 630 B3, EP 2 308 602 B1, U.S. Pat. No. 7,617,955 B2 and U.S. Pat. No. 8,333,307 B2. Specifically, the device of EP 2 308 602 B1 comprises a head portion and a base body portion, wherein the device comprises a cavity for receiving the fluid medium. The head portion comprises a dispensing opening, leading into the cavity, for dispensing the fluid medium. The device furthermore comprises a rod, which is displaceable in an axial direction between a first end position and a second end position, wherein a first end portion of the rod comprises a sealing portion. The sealing portion, in the first end position, is arranged spaced from the dispensing opening and therefore enables dispensing of the adhesive in the first end position. In the second end position, the sealing portion of the rod closes the dispensing opening on a side facing the cavity. A second end portion of the rod is guided out of the cavity and coupled to an actuator, specifically to a piston of a compressed-air cylinder. The device comprises a seal for sealing a region of the device which receives the second end portion of the rod with respect to the cavity. The seal is arranged in the region of the cavity, wherein the seal surrounds the rod circumferentially in the region of the cavity. The seal is formed as a bellows seal, wherein the seal comprises a first seal portion and a second seal portion, wherein the first seal portion is in sealing engagement with the rod such that it is stationary with respect to the rod, hence connected to the rod in a stationary manner. Owing to the stationary connection of the first seal portion to the rod, the first seal portion follows a movement of the rod. The second seal portion abuts in a stationary manner against a wall delimiting the cavity. Between the first seal portion and the second seal portion, the seal comprises an area of elasticity in order to compensate or accommodate the relative movement of the rod with respect to the cavity, specifically with respect to the wall delimiting the cavity, against which the second seal portion abuts. In EP 2 308 602 B1, it is furthermore provided that the seal is squeezed or compressed in the axial direction.

The compression or squeezing of the seal is disadvantageous in that a relatively high force has to be applied for the purpose of opening the dispensing opening since the opening of the dispensing opening takes place in opposition to the spring force of the seal, which is present as a result of the squeezing action. This has a disadvantageous effect on the force to be delivered to the actuator and the time required for opening and closing the dispensing opening.

### OBJECT AND SUMMARY OF THE INVENTION

The object of the present invention is to further develop or modify a device for dispensing a fluid medium in such a way that it still has the necessary sealing effect and durability whilst overcoming the above-mentioned disadvantages.

To achieve the above-mentioned object, it is provided that the seal, in the second end position of the rod, is stretched or elongated in the axial direction in relation to an initial state of the seal.

Accordingly, in the state in which the dispensing opening is closed, the area of elasticity of the seal is elongated and the movement of the rod for opening the dispensing opening, i.e. for transferring the rod from the second end position into the first end position, is therefore promoted by the pre-stress of the area of elasticity of the seal, whereby the force to be applied by the actuator is reduced and the seal, as such, promotes the movement of the rod from the second end position into the first end position.

As a result of the fact that the fluid medium present in the cavity is typically under pressure and therefore acts accordingly on the seal, the forces present in the seal as a result of the stretching or elongation thereof are preferably partially compensated so that very good durability can be achieved.

In particular, it is provided that the elongation or stretching of the seal is configured in such a way that, with a known prevailing pressure of the fluid medium during operation of the device, the forces present in the seal and acting in the axial direction disappear in the second end position of the rod. The durability and therefore the useful life of the seal can thus be increased.

In a preferred embodiment of the device, the first seal portion is connected to the rod with material fit.

It is regarded as particularly advantageous if, without the effect of an external force on the rod and/or on the seal, the rod is located in the first end position or the rod is located between the first end position and the second end position. Therefore, for the purpose of closing the dispensing opening, a force has to be exerted on the rod in the direction of the second end position.

It is regarded as particularly advantageous if the device comprises means for exerting an external force on the rod in the direction of the second end position, in particular a displacement of the rod in the direction of the first end position takes place in opposition to the force of the exerting means. The exerting means can, for example, comprise a spring or be formed by a spring. It is regarded as particularly advantageous if, without the effect of the actuator on the rod, the rod is located in the second end position.

The exerting means preferably comprise a stop, wherein the stop is axially displaceably mounted in the base body potion and cooperates with the rod and/or the actuator. The exerting means furthermore comprise a restoring means cooperating with the stop, wherein a displacement of the stop in the direction of the first end position of the rod takes place in opposition to the restoring force of the restoring means. The restoring means can be formed, for example, as a spring.

The second seal portion is preferably connected with a form fit and/or a force fit and/or a material fit to the wall delimiting the cavity.

In a preferred embodiment of the device, the second seal portion of the seal is arranged, in particular held in a clamping manner, between the head portion and the base body potion.

In terms of a particularly good sealing effect of the seal, it is regarded as advantageous if the seal comprises a circumferential bead in the region of the second seal portion. The bead is formed in particular on a side facing the actuator; hence, it protrudes in the axial direction.

Manufacturing tolerances which may occur can also be compensated by the circumferential bead.

When the second seal portion is held in a clamping manner between the head portion and the base body portion, the bead furthermore facilitates that the forces which occur during the clamping procedure can be non-destructively absorbed by the second seal portion.

The device comprises at least one inlet opening, leading into the cavity, for supplying the fluid medium into the cavity. In terms of a particularly homogenous distribution of the fluid medium in the cavity or a particularly homogenous supply of the fluid medium into the cavity, it is provided in a particularly preferred embodiment that the device comprises a plurality of inlet openings leading into the cavity, wherein the inlet openings are arranged circumferentially around the rod.

The inlet openings are preferably arranged evenly, in particular equidistantly.

It is regarded as particularly advantageous if an angular spacing of the inlet openings is about 360° divided by the number of inlet openings.

The device preferably comprises an odd number of inlet openings. An odd number of inlet openings has proven particularly advantageous in terms of the supply being as homogenous as possible. The device particularly preferably comprises five inlet openings.

To supply the fluid medium particularly homogenously and therefore to also exert a load or pressure on the seal in a particularly homogenous manner, it is provided in a preferred embodiment that the inlet openings are arranged along a circular circumference of a circle, wherein a circular plane of the circle is formed perpendicularly to the axial direction.

For a particularly even flow onto the seal, it is regarded as advantageous if the inlet openings have different-sized cross-sectional areas.

In a particularly preferred embodiment of the device, the device comprises an annular channel for supplying the fluid medium to the plurality of inlet openings. In particular, it is provided that the annular channel surrounds the rod circumferentially. However, the annular channel does not necessarily have to be closed, which means that it is feasibly conceivable for the annular channel to surround the rod only partially, for example to surround the rod in an angular range of about 270°.

In terms of a particularly simple supply of the fluid medium into the channel, it is regarded as advantageous if the device comprises an externally accessible supply line, wherein the supply line leads into the annular channel.

The supply line can comprise, in particular, a connection for connecting a hose for the purpose of supplying the fluid medium.

It is regarded as particularly advantageous if, in the exit direction of the supply line, the channel is free from inlet openings leading into the cavity.

In an embodiment having a plurality of inlet openings, it is regarded as particularly advantageous if a cross-sectional area of an inlet opening which has a smaller spacing from the supply line than another inlet opening is smaller than a cross-sectional area of the other inlet opening. It is thus facilitated that the flow onto the seal is as homogenous as possible.

The second seal portion of the seal is formed in particular as a flange. This enables particularly simple assembly of the seal with a particularly good sealing effect.

The seal is preferably formed as a bellows seal. The bellows seal can feasibly be a gaiter seal.

In a preferred embodiment, it is provided that at least a segment of the area of elasticity of the seal is arranged spaced from the rod in a radial direction. This prevents frictional contact and therefore frictional forces, which have a negative effect on the useful life of the seal.

In an advantageous further development, it is provided that the seal has a constant wall thickness in the area of elasticity. A seal of this type is particularly simple and cost-effective to manufacture and, owing to the special design of the device, namely that the seal, in the second end position of the rod, is stretched or elongated in the axial direction in relation to the initial state of the seal, still has the necessary durability.

It is regarded as particularly advantageous if the area of elasticity has a curvature in a planar cross-section of the seal formed parallel to the axial direction. In this context, the term “planar cross-section” refers to a section along a plane. In this regard, the term “planar cross-section” is used to differentiate from a stepped cross-section, also referred to as a step section. In particular, it is provided that the curvature of the area of elasticity can be described by a center line of the cross-section of the area of elasticity, wherein a curvature of the center line is constant. The constant curvature of the center line ensures that the changes in the stress in the seal have a constant behavior. The shape of the center line can be described in particular by a segment of a quadratic sine function.

The seal preferably has an axis of symmetry and the above-mentioned cross-section extends through the axis of symmetry of the seal. The axis of symmetry of the seal preferably extends through the rod of the device.

In a particularly advantageous further development, it is provided that the rod is designed in at least two parts, wherein a first rod part comprises the sealing portion, wherein the first rod part comprises a receptacle for a second rod part, wherein the second rod part is arranged in the receptacle and wherein the first seal portion is connected to the first rod part.

The first seal portion is preferably connected the first rod part and/or to the second rod part with a force fit and/or a form fit and/or a material fit.

In a particularly advantageous further development, it is provided that the first seal portion is mounted in a clamping manner between the first rod part and the second rod part.

To achieve a particularly good useful life, it is provided in an advantageous further development that the area of elasticity comprises a first contact portion adjoining the first seal portion and the rod comprises a first anti-friction portion, wherein the first contact portion contacts the first anti-friction portion, and/or the area of elasticity comprises a second contact portion adjoining the second seal portion and the device comprises a wall portion surrounding the rod circumferentially, wherein the wall portion comprises a second anti-friction portion, wherein the second contact portion contacts the second anti-friction portion on a side remote from the rod. During the actuation of the rod and the simultaneous elastic deformation of the seal, a sliding movement possibly takes place via the corresponding anti-friction portions. As a result of the anti-friction portions, damage to the seal is also prevented during assembly and the initial operation. In particular, to reduce the frictional forces which occur, it is provided that the respective anti-friction portion has a coating and/or is less rough than a region of the rod which adjoins the first anti-friction portion.

The actuator is preferably a pneumatically actuable piston. The piston is preferably guided in a sealed manner in a cylinder, wherein the piston divides the cylinder into a first cylinder portion and a second cylinder portion, wherein the respective cylinder portion comprises a connection for supplying compressed air. One connection is acted upon by compressed air for the purpose of opening the dispensing opening and the other connection is acted upon by compressed air for the purpose of closing the dispensing opening.

In a particularly advantageous further development, it is provided that the interior of the cylinder is sealed by a further seal, wherein an overflow channel is provided in the device, between the cavity and the further seal, wherein the overflow channel is mounted downstream of the seal, which serves for sealing the region of the device which receives the second end portion of the rod with respect to the cavity. The overflow channel is formed in the region of the device which receives the second end portion and serves for discharging misrouted media which have penetrated into this region of the device and which, in spite of the seal, reach this region, for example, as a consequence of damage to the seal or wear on the seal or damage and/or wear at the connection between the seal and the rod. The overflow channel and the further seal prevent, in particular, that misrouted media reach the region of the actuator.

### BRIEF DESCRIPTION OF THE DRAWING FIGURES

In the accompanying drawing figures, the invention is illustrated with the aid of an exemplary embodiment, without being restricted thereto.

FIG. 1 shows a device for dispensing a fluid medium, in a sectional view.

FIG. 2 shows a partial region of the device according to FIG. 1, in a sectional view.

FIG. 3 shows the device according to FIG. 1, in a perspective view.

FIG. 4 shows the device according to FIG. 1, in a second perspective view.

### DETAILED DESCRIPTION OF PREFERRED EMBODIMENTS OF THE INVENTION

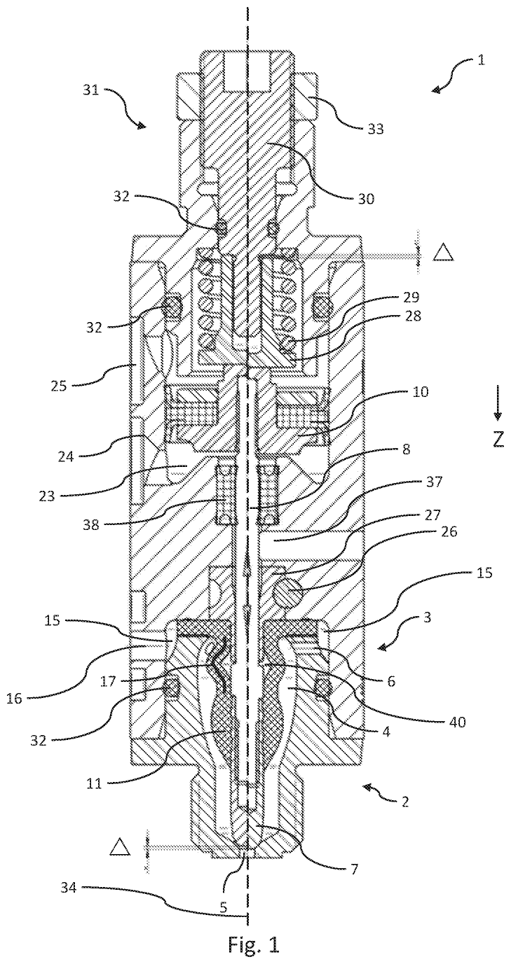

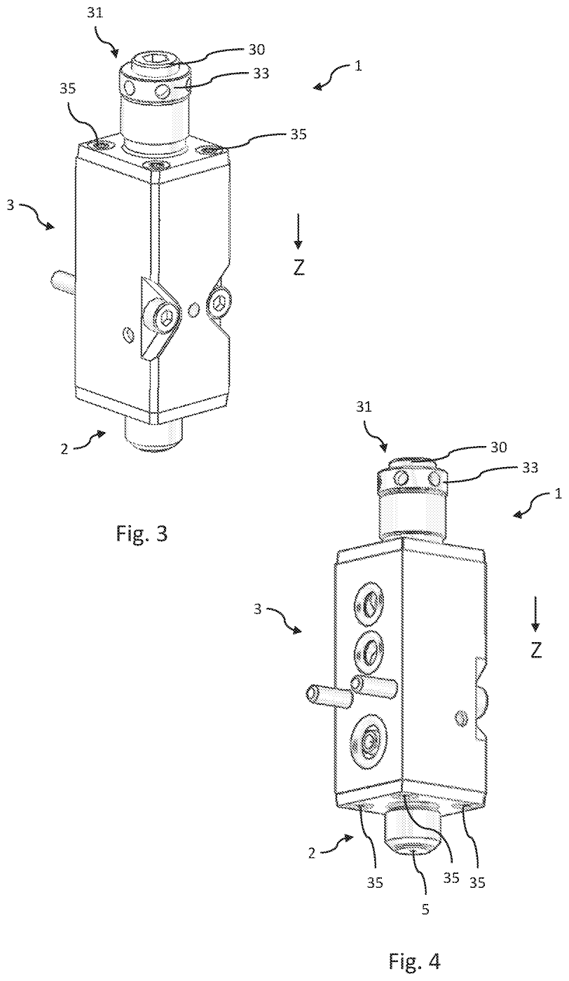

FIGS. 1 to 4 show a first embodiment of a device 1 for dispensing a fluid medium according to the invention; in the present case, for dispensing a hot melt adhesive. The device 1 comprises a head portion 2 and a base body portion 3. In this case, the head portion 2 is inserted into the base body portion 3 and screwed to the base body portion 3 at the end face by means of four screws 35. For sealing purposes, a sealing ring 32 is arranged between the base body portion 3 and the head portion 2. The device 1 comprises a cavity 4, wherein this cavity 4 serves for receiving the fluid medium. In the present case, the cavity 4 is formed in the head portion 2. The head portion 2 comprises a dispensing opening 5, leading in the cavity 4, for dispensing the fluid medium; in the present case, the hot melt adhesive. The device 1 furthermore comprises a rod 7, 8, wherein the rod 7, 8 in the present case is designed in two parts, namely a first rod part 7 and a second rod part 8, wherein the first rod part 7 comprises a receptacle for the second rod part 8, wherein the second rod part 8 is arranged in the receptacle. In the present case, the second rod part 8 comprises an external thread, wherein the first rod part 7 comprises, in the region of the receptacle, an internal thread corresponding to the external thread of the second rod part 8. For the purpose of connecting the first rod part 7 to the second rod part 8, the second rod part 8 is screwed into the thread of the first rod part 7 and preferably additionally bonded to the first rod part 7.

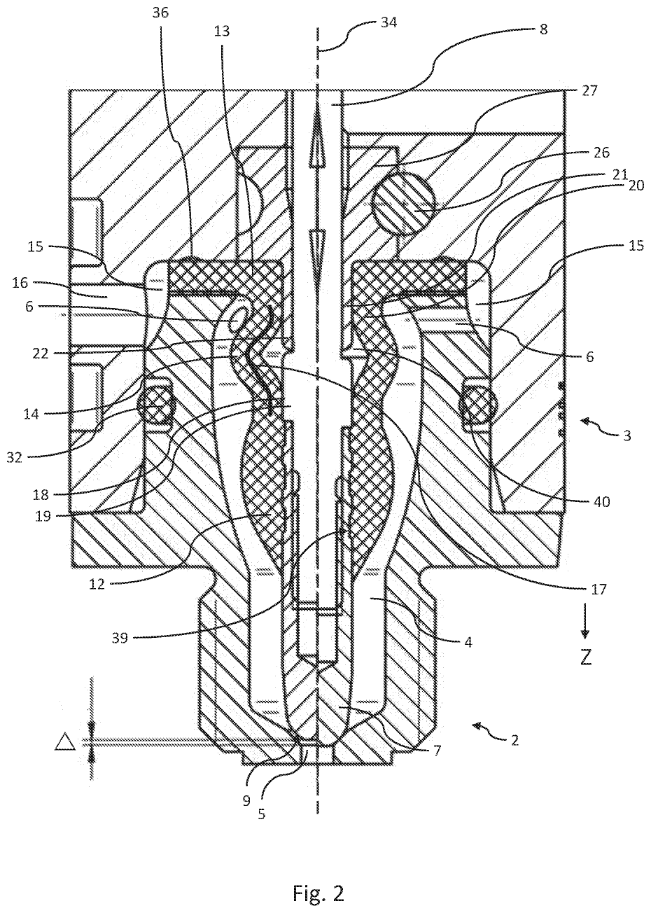

The rod 7, 8 is displaceable in an axial direction Z between a first end position and a second end position. These two positions are illustrated in FIG. 1 and FIG. 2, wherein the left half of the respective drawing shows the rod 7, 8 or the device 1 in the first end position of the rod 7, 8 and the right half of the respective drawing shows the rod 7, 8 or the device 1 in the second end position of the rod 7, 8.

The rod 7, 8 comprises a first end portion which, in the present case, is formed by the first rod part 7. The first end portion comprises a sealing portion 9, which serves for the sealed closure of the dispensing opening 5 in the second end position of the rod 7, 8.

In the first end position of the rod 7, 8, the sealing portion 9 is arranged spaced from the dispensing opening 5 and, in the second end position, the sealing portion 9 closes the dispensing opening 5 on a side facing the cavity 4. The axial spacing between the sealing portion 9 in the first end position and the position of the sealing portion 9 in the second end position is denoted by the reference sign A. The spacing A is identical to the stroke of the stroke movement of the rod 7, 8. To move the rod 7, 8, a second end portion of the rod 7, 8, which, in the present case, is formed by the second rod part 8, is guided out of the cavity 4 and coupled to an actuator 10; in the present case a piston of a pneumatic cylinder 23; in the present case mounted in the piston 10. The cylinder 23 comprises two cylinder portions separated by the piston 10, wherein a first connection 24 leads into the cylinder portion facing the head portion 2 and a second connection 25 leads into the cylinder portion remote form the head portion 2. For the purpose of transferring the rod 7, 8 from the second end position into the first end position, the first connection 24 is acted upon by compressed air. For transferring the rod 7, 8 from the first end position into the second end position, the second connection 25 is correspondingly acted upon by compressed air.

A stop 28 is used to delimit the stroke of the rod 7, 8 and therefore the sealing portion 9. The stop 28 is arranged in a cover 31, wherein the cover 31 is in turn screwed to the base body portion 3 at the end face by means of screws 35. The stop 28 is displaceably mounted in the cover 31, wherein a displacement of the stop 28 in the opening direction of the rod 7, 8 takes place in opposition to the restoring force of a restoring means 29 formed as a spring. In this regard, the stop 28 and the restoring means 29 form means which exert an external force on the rod 7, 8 in the direction of the second end position. In an unpressurized state of the device 1, the rod 7, 8 is pushed by the stop 28 in the direction of the second end position of the rod 7, 8. It is therefore prevented that, in an unpressurized state, fluid medium, in the present case adhesive, escapes from the exit opening 5. The advantage likewise exists that air moisture cannot enter into the cavity 4. This means that, when using a reactive medium, for example polyurethane (PUR), this cannot harden. The position of the stop 28 and therefore the stroke of the rod 7, 8 can be altered by means of the adjusting means 30 formed as an adjusting screw, in that this is screwed to a greater or lesser extent into the cover 31 or into the base body portion 3. Therefore, by means of the adjusting means 30, manufacturing tolerances can be compensated and a fine adjustment of the stroke movement of the rod 7, 8 can be undertaken. To prevent a loosening the adjusting means 30, the adjusting means 30 is secured by a lock nut 33.

To seal a region of the device 1 which receives the second end portion and therefore to also seal the actuator 10 with respect to the cavity 4, the device 1 comprises a seal 11 which, in the present case, is formed as a bellows seal.

This seal 11 is arranged in the region of the cavity 4 and surrounds the rod 7, 8 circumferentially in the region of the cavity 4. The seal 11 comprises a first seal portion 12 and a second seal portion 13, wherein the first seal portion 12 is connected in a stationary and sealing manner to the rod 7, 8, in the present case the first rod part 7, and wherein the second seal portion 13 abuts in a stationary and sealing manner against a wall delimiting the cavity 4.

The seal 11 prevents, in particular, that the hot melt adhesive reaches the intermediate region 40 between the seal 11 and the rod 7, 8 and, from there, the region of the device 1 which receives the second end portion.

As a result of the first seal portion 12 being connected to the rod 7, 8 such that it is stationary with respect to the rod 7, 8, the first seal portion 12 follows the movement of the rod 7, 8.

In the present case, the second seal portion 13 is formed as a flange, wherein the second seal portion 13 is held in a clamping manner between the head portion 2 and the base body portion 3.

To also ensure good sealing if manufacturing tolerances occur, the second seal portion 13 comprises a circumferential bead 36, wherein this circumferential bead 36 is formed on a side facing the actuator 10. The bead 36 furthermore facilitates that the forces which occur on the second seal portion 13 when the head portion 2 is screwed to the base body portion 3 can be non-destructively absorbed by the second seal portion 13.

The seal 11 comprises an area of elasticity 14 between the first seal portion 12 and the second seal portion 13. This area of elasticity 14 serves for compensating the change in the spacing between the first seal portion 12 and the second seal portion 13, which occurs when the rod 7, 8 is displaced for the purpose of transferring the rod 7, 8 from the first end position into the second end position, and vice versa.

In the present case, the seal 11 or the arrangement of the seal 11 in the device 1 is configured in such a way that, in the second end position of the rod 7, 8, the seal 11 is stretched or elongated in the axial direction Z in relation to an initial state of the seal 11.

In the present exemplary embodiment, it is provided that the first seal portion 12 is connected with material fit to the rod 7, 8. The first rod part 7 comprises, at the connecting surface to the first seal portion 12, a plurality of preferably circumferential undercuts 39, spaced in the axial direction Z, in order to be able to better absorb the axial forces occurring in this region, which are generated by the applied pressure of the adhesive and by the actuating forces of the rod 7, 8.

The device 1 comprises a plurality of inlet openings 6, specifically five inlet openings 6, leading into the cavity 4. These inlet openings 6 are arranged circumferentially and equidistantly around the rod 7, 8. In the present case, the inlet openings 6 are arranged along a circular circumference of a circle, wherein a circular plane of the circle is formed perpendicularly to the axial direction Z.

In the present case, the inlet openings 6 have different-sized cross-sectional areas, specifically different-sized diameters.

This configuration of the inlet openings 6 ensures that the fluid medium, in the present case the adhesive, flows evenly into the cavity 4 and is therefore distributed evenly over the entire circumference of the seal 11, and, in particular, that dead spaces, in which the adhesive accumulates and is therefore not supplied to the dispensing opening 5, are not produced in the cavity 4. This configuration of the inlet openings 6 furthermore has the advantage of ensuring that the flow of adhesive into the cavity 4, and therefore in the direction of the seal 11, is as even as possible, whereby it is achieved that the load on the seal 11 is as rotationally symmetrical as possible. This has a positive effect on the durability of the seal 11.

The device 1 furthermore comprises an annular channel 15 for supplying the fluid medium to the plurality of inlet openings 6. This annular channel 15 surrounds the rod 7, 8 circumferentially. In the present case, the circumferential channel 15 is formed by an annular gap between the base body portion 3, the head portion 2 and the second seal portion 13.

The device 1 comprises an externally accessible supply line 16, wherein the supply line 16 leads into the annular channel 15 and serves for supplying adhesive or a fluid medium into the device 1, specifically the channel 15, from the outside.

A segment of the area of elasticity 14 of the seal 11 is arranged spaced from the rod 7, 8 in a radial direction. In this case, the radial direction is aligned perpendicularly to the axial direction Z.

As can be seen in particular in FIG. 2, the area of elasticity 14 has, in a planar cross-section of the seal 11 extending through a center axis 34 of the rod 7, 8, a curvature which can be described by a center line 17 of the cross-section of the area of elasticity 14. The curvature of the center line 17 is constant; in the present case, it can be described by a segment of a quadratic sine function.

The area of elasticity 14 comprises a first contact portion 18 adjoining the first seal portion 12, and the rod 7, 8 comprises a first anti-friction portion 19, wherein the first contact portion 18 contacts the first anti-friction portion 19. In terms of the first anti-friction portion 19, it is regarded as particularly advantageous if the first anti-friction portion 19 has a coating and/or is less rough than a region of the rod 7, 8 which adjoins the first anti-friction portion 19.

The area of elasticity 14 furthermore likewise comprises a second contact portion 20 adjoining the second seal portion 13, and the device 1 comprises a wall portion 22 surrounding the rod 7, 8 circumferentially, wherein the wall portion 22 comprises a second anti-friction portion 21, wherein the second contact portion 20 contacts the second anti-friction portion 21 on a side remote from the rod 7, 8. In the case of the second anti-friction portion 21, it is also regarded as advantageous if this has a coating and/or is less rough than a region of the wall portion 22 which adjoins the second anti-friction portion 21.

The device 1 comprises a guide sleeve 27, wherein the guide sleeve 27 is mounted in the base body portion 3. The guide sleeve 27 serves for receiving the second end portion of the rod 7, 8, wherein the second end portion of the rod 7, 8 passes through the guide sleeve 27. The guide sleeve 27 comprises a circumferential groove, wherein the base body portion 3 comprises a bore, adjoining the groove, wherein, for stable mounting of the guide sleeve 27 in the base body portion 3, a holding pin 26 is introduced into the groove and the bore adjoining the groove.

The guide sleeve 27 receives the second end portion of the rod 7, 8 and serves for guiding the movement of the rod 7, 8. The guide sleeve 27 comprises the second anti-friction portion 21 in the region of the wall portion 22.

The inlet openings 6, the annular channel 15, the cavity 4, the seal 11, regardless of the different-sized diameters of the inlet openings 6, are all formed to be radially or rotationally symmetrical, and in particular concentric, to the rod 7, 8.

To seal the device 1 or components of the device 1 with respect to one another, the device 1 comprises a sealing ring 32 between the head portion 2 and the base body portion 3, a sealing ring 32 between the cover 31 and the base body portion 3 and likewise a sealing ring 32 between the adjusting means 30 and an outer wall of the cover 31. A further seal 38 is furthermore arranged between the second rod part 8 and the base body portion 3, in the region between the cylinder 23 and an overflow channel 37.

The overflow channel 37 is mounted downstream of the seal 11 which serves for sealing the region of the device 1 which receives the second end portion of the rod 7, 8 with respect to the cavity 4. The overflow channel 37 is formed in the region of the device 1 which receives the second end portion and serves for discharging misrouted hot melt adhesive which has penetrated into this region of the device 1 and which reaches this region in spite of the seal 11. The overflow channel 37 and the further seal 38 prevent, in particular, that misrouted hot melt adhesive reaches the region of the actuator 10.

The seal 11 is manufactured such that, in an installed state of the seal 11, the rod 7, 8 is located in the first end position without external loads. The seal 11 is preferably installed without any pre-stress of the area of elasticity 14.

The device 1 is preferably manufactured in such a way that, at the design point, stresses in the seal 11 substantially disappear in the axial direction, i.e. the boundary conditions, such as the size of the stroke movement, temperature, pressure of the adhesive or pressure of the medium, and viscosity, are selected such that the stresses applied in the seal 11 substantially disappear in the axial direction Z.

In terms of particularly simple and cost-effective manufacture, it is regarded as advantageous if the seal 11 is firstly connected to the first rod part 7 by the first seal portion 12. The second rod part 8 is subsequently connected to the first rod part 7; in the present case, screwed and possibly bonded thereto. Care should be taken here to avoid damage to the seal 11 when screwing the second rod part 8 into the first rod part 7.

That which is claimed is:

1. A device for dispensing a fluid medium, wherein the device comprises a head portion and a base body portion, wherein the device further comprises a cavity for receiving the fluid medium, wherein the head portion comprises a dispensing opening leading into the cavity for dispensing the fluid medium, wherein the device further comprises a rod that is displaceable in an axial direction between a first end position and a second end position, wherein a first end portion of the rod comprises a sealing portion that in the first end position is arranged spaced from the dispensing opening and that in the second end position closes the dispensing opening on a side facing the cavity, wherein a second end portion of the rod is guided out of the cavity for coupling the rod to an actuator, wherein the device further comprises a seal for sealing a region of the device which receives the second end portion with respect to the cavity, wherein the seal is arranged in the region of the cavity and surrounds the rod circumferentially in the region of the cavity, wherein the seal comprises a first seal portion and a second seal portion, wherein the first seal portion is connected to the rod such that it is stationary with respect to the rod and the second seal portion abuts in a stationary manner against a wall delimiting the cavity, wherein the seal comprises an area of elasticity between the first seal portion and the second seal portion, wherein the seal, in the second end position of the rod, is stretched in the axial direction in relation to an initial state of the seal.

2. The device as claimed in claim 1, wherein the first seal portion is connected to the rod with a material fit.

3. The device as claimed in claim 1, wherein, without the effect of an external force on the rod and/or without the effect of an external force on the seal, the rod is located in the first end position, or, without the effect of an external force on the rod and/or without the effect of an external force on the seal, the rod is located between the first end position and the second end position.

4. The device as claimed in claim 3, further comprising means for exerting an external force on the rod in the direction of the second end position.

5. The device as claimed in claim 1, further comprising a plurality of inlet openings leading into the cavity, and wherein the inlet openings are arranged circumferentially around the rod.

6. The device as claimed in claim 5, wherein the inlet openings are arranged along a circular circumference of a circle, and wherein a circular plane of the circle is formed perpendicularly to the axial direction.

7. The device as claimed in claim 5, further comprising an annular channel for supplying the fluid medium to the plurality of inlet openings.

8. The device as claimed in claim 1, wherein the second seal portion is formed as a flange.

9. The device as claimed in claim 1, wherein the seal is formed as a bellows seal.

10. The device as claimed in claim 1, wherein at least a first segment of the area of elasticity of the seal is arranged spaced from the rod in a radial direction.

11. The device as claimed in claim 10, wherein at least a second segment of the area of elasticity protrudes with respect to the first seal portion in the radial direction.

12. The device as claimed in claim 1, wherein the seal has a constant wall thickness in the area of elasticity.

13. The device as claimed in claim 1, wherein the area of elasticity has a curvature in a planar cross-section of the seal formed parallel to the axial direction that is described by a center line of the cross-section of the area of elasticity.

14. The device as claimed in claim 1, wherein the rod is designed in at least two parts, wherein a first rod part comprises the sealing portion, and wherein the first seal portion is connected to the first rod part and/or the first seal portion is mounted in a clamping manner between the first rod part and the second rod part.

15. The device as claimed in claim 1, wherein the area of elasticity comprises a first contact portion adjoining the first seal portion and the rod comprises a first anti-friction portion, wherein the first contact portion contacts the first anti-friction portion and/or the area of elasticity comprises a second contact portion adjoining the second seal portion and the device further comprises a wall portion surrounding the rod circumferentially, wherein the wall portion comprises a second anti-friction portion and wherein the second contact portion contacts the second anti-friction portion on a side remote from the rod.

16. The device as claimed in claim 1, wherein the device dispenses an adhesive.

17. The device as claimed in claim 16, wherein the adhesive is a hot melt adhesive.

18. The device as claimed in claim 7, wherein the annular channel surrounds the rod circumferentially.

19. The device as claimed in claim 13, wherein a curvature of the center line is constant.

20. The device as claimed in claim 19, wherein the center line is described by a segment of a quadratic sine function.
